(19) United States
(12) Patent Application Publication
(10) Pub. No.: US 2026/0126081 A1
(43) Pub. Date: May 7, 2026

(54) SEAL FOR WHEEL BEARING OF VEHICLE AND WHEEL BEARING FOR VEHICLE COMPRISING SAME

(71) Applicant: ILJIN GLOBAL CO., LTD., Seoul (KR)

(72) Inventors: Yong Won KIM, Anyang-si Gyeonggi-do (KR); Seong Kyu JIN, Jinju-si Gyeongsangnam-do (KR)

(73) Assignee: ILJIN GLOBAL CO., LTD., Seoul (KR)

(21) Appl. No.: 19/434,422

(22) Filed: Dec. 29, 2025

Related U.S. Application Data
(63) Continuation of application No. PCT/KR2024/006838, filed on May 21, 2024.

(30) Foreign Application Priority Data
Jun. 29, 2023 (KR) 10-2023-0084355

(51) Int. Cl. F16C 33/78; F16C 19/38

(52) U.S. Cl. CPC F16C 33/7823; F16C 19/38; F16C 2326/02

(57) ABSTRACT

A vehicle wheel bearing seal includes a first seal portion including a first support member coupled to an inner ring of a vehicle wheel bearing and a first seal-portion body coupled to the first support member; and a second seal portion including a second support member coupled to an outer ring of the wheel bearing and a second seal-portion body coupled to the second support member. The first support member includes a first cylindrical portion in contact with an outer diameter surface of the inner ring, a first annular portion extending radially outwardly from an axial outer end portion of the first cylindrical portion, and a second cylindrical portion extending axially inwardly from a radial outer end portion of the first annular portion and facing the first cylindrical portion. The second seal-portion body includes a grease rib not to be in contact with the first cylindrical portion.

### CROSS-REFERENCE TO RELATED APPLICATIONS

This application is a continuation of International Application No. PCT/KR2024/006838 filed on May 21, 2024, which claims priority to Korean Patent Application No. 10-2023-0084355 filed on June 29, 2023, the entire contents of which are herein incorporated by reference.

### TECHNICAL FIELD

The present disclosure relates to a vehicle wheel bearing seal, and a vehicle wheel bearing including the same.

### BACKGROUND

A bearing is a device mounted between a rotary element and a non-rotary element to facilitate rotation of the rotary element. A vehicle wheel bearing is one kind of such a bearing, and functions to rotatably connect a wheel, which is a rotary element, relative to a non-rotary vehicle body or a knuckle.

Such a vehicle wheel bearing may include an outer ring coupled to the vehicle body, an inner ring coupled to an axle, rolling bodies provided between the inner ring and the outer ring to implement the rotation of the inner ring relative to the outer ring, and a seal member for preventing foreign matters from being introduced into an interior of the vehicle wheel bearing. The seal member may include a seal rib which is in contact with the inner ring to prevent the foreign matters from being introduced into the interior of the vehicle wheel bearing.

The seal member may include a plurality of seal ribs. At least some of the plurality of seal ribs are disposed near a support member coupled to the outer ring and are brought into contact with a support member coupled to the inner ring. The seal ribs in contact with the support member are configured to press the support member.

In general, the seal member of the vehicle wheel bearing is assembled and transported after manufacture, and then mounted on the vehicle wheel bearing. However, since the seal member is transported in the assembled state so that the seal ribs press the support member coupled to the inner ring, the support member (inner convex portion) coupled to the outer ring and the support member (outer convex portion) coupled to the inner ring may be separated from each other during the transport.

### SUMMARY

The present disclosure was made to solve the above-mentioned matters, and the present disclosure is for the purpose of providing a vehicle wheel bearing seal and a vehicle wheel bearing using the same, which are capable of ensuring a sealing property and reducing a sealing drag torque generated by a seal member, thereby improving a fuel efficiency of a vehicle.

A vehicle wheel bearing seal according to an example embodiment of the present disclosure may include: a first seal portion including a first support member coupled to an inner ring of the vehicle wheel bearing and a first seal-portion body coupled to the first support member; and a second seal portion including a second support member coupled to an outer ring of the vehicle wheel bearing and a second seal-portion body coupled to the second support member. The first support member may include a first cylindrical portion configured to be in contact with an outer diameter surface of the inner ring, a first annular portion extending in a radially outward direction from an axial outer end portion of the first cylindrical portion, and a second cylindrical portion extending in an axially inward direction from a radial outer end portion of the first annular portion and configured to face the first cylindrical portion. The second seal-portion body may include a grease rib configured not to be in contact with the first cylindrical portion.

In an aspect, at least one protrusion may be formed at an axial outer end portion of the second seal-portion body in a radially inward direction. A stepped portion may be formed in the first seal-portion body so as to correspond to the at least one protrusion. The stepped portion may be formed to be opened in an axially outward direction and the radially outward direction.

The at least one protrusion may have a plurality of protrusions arranged to be spaced apart from each other at equal intervals along an inner peripheral surface of the second seal-portion body.

According to an example embodiment of the present disclosure, a first labyrinth may be formed by the at least one protrusion, a second labyrinth may be formed by the stepped portion, a third labyrinth may be formed by the first seal-portion body which covers the second cylindrical portion, and a fourth labyrinth may be formed by the first seal-portion body which covers an end of the second cylindrical portion.

The second support member may include a third cylindrical portion configured to be in contact with an inner diameter surface of the outer ring, and a second annular portion extending in the radially inward direction from an axial outer end portion of the third cylindrical portion. The second seal-portion body may be configured to cover all of an axial outer surface of the second support member, a radial inner end portion of the second annular portion, and the axial outer end portion of the third cylindrical portion.

An axial interference amount T between the at least one protrusion and the stepped portion may be 0.1 millimeter (mm) or more. Further, an inner surface of the at least one protrusion may be formed as an inclined surface.

The stepped portion may be formed in a ring shape along a radial outer peripheral surface of the first seal-portion body. A length of an outermost diameter flat section of the first seal-portion body which covers the second cylindrical portion in the stepped portion may be 1.0 mm or more. An axial width and a radial depth of the stepped portion may be 0.5 mm or more, respectively.

A recess may be formed in an outer surface of a portion of the first seal-portion body which covers the first annular portion to be depressed in the axially inward direction and to be opened in an axially outward direction.

In as aspect, the vehicle wheel bearing seal according to an example embodiment of the present disclosure may include the seal for the vehicle wheel bearing of any one of the aforementioned configurations.

According to a vehicle wheel bearing seal of the present disclosure, it is possible to prevent an inner convex portion and an outer convex portion from being separated from each other in the seal for the vehicle wheel bearing in an assembled state, ensure a sealing property and reduce a sealing drag torque generated by a seal member, thereby improving a fuel efficiency of a vehicle.

### BRIEF DESCRIPTION OF THE DRAWINGS

FIG. 1 is a cross-sectional view of a vehicle wheel bearing according to an example embodiment of the present disclosure.

FIG. 2 is an enlarged view of a first region A illustrated in FIG. 1.

FIG. 3 is an enlarged view of a second region B illustrated in FIG. 1.

FIG. 4 is a view of a second seal-portion body according to an example embodiment of the present disclosure, when view in an axially inward direction

FIG. 5 is a view illustrating a labyrinth structure according to an example embodiment of the present disclosure

FIG. 6 illustrates a vehicle wheel bearing seal according to another example embodiment of the present disclosure.

### DETAILED DESCRIPTION

Advantages and features of the present disclosure, and a method of achieving them, will become more apparent by example embodiments described below in detail in conjunction with the accompanying drawings. However, the present disclosure is not limited to example embodiments which will be described later, and may be implemented in various different forms. The present example embodiments merely completely describe the present disclosure, and are provided to faithfully explain the scope of the present disclosure to those skill in the art to which the present disclosure pertains. The present disclosure is merely defined by the scope of the claims. Throughout the specification, like reference numerals refer to like constituent elements.

Throughout the present specification, when a constituent element is referred to as being arranged "above" or "on" another constituent element, the constituent element may be arranged "directly above" another constituent element, or may be arranged above another constituent element by intervening yet another constituent element therebetween. Further, the term "and/or" may be used to represent a combination of a plurality of related items described herein or at least one of the plurality of related items.

Spatially relative terms such as "below," "beneath," "lower," "above," "upper," and the like may be used to easily explain a correlation between a constituent element and another constituent element as illustrated in the drawings. Such spatially relative terms should be understood as encompassing different directions of the constituent element in use or during operation, in addition to directions illustrated in the drawings. Throughout the present specification, the same reference numerals will be given to the same constituent elements.

Further, although the terms including ordinal numbers such as a first, a second and the like used herein may be used to describe various constituent elements and/or various sections, such constituent elements and/or various sections should not be limited by terms including the ordinal numbers. The above terms may be merely used to distinguish a constituent element or a section from another constituent element or another section. For example, a first constituent element or a first section used herein may be named as a second constituent element or a second section in another description of the specification without departing from the scope of the present disclosure.

Example embodiments of the present disclosure will be described with reference to schematic plan views and cross-sectional views illustrated in the present specification. Explanatory diagrams may be modified according to a manufacturing technique and/or an allowable error. The example embodiments of the present disclosure are not limited to specific forms illustrated herein, but may also encompass a case where a mode is changed according to a manufacturing process. Further, regions illustrated in the drawings have schematic attributes, and patterns of the regions illustrated in the drawings merely illustrate specific forms of the regions in a configuration, which are not intended to limit the scope of the present disclosure.

Hereinafter, a preferred example embodiment of the present disclosure will be described in more detail with reference to the accompanying drawings.

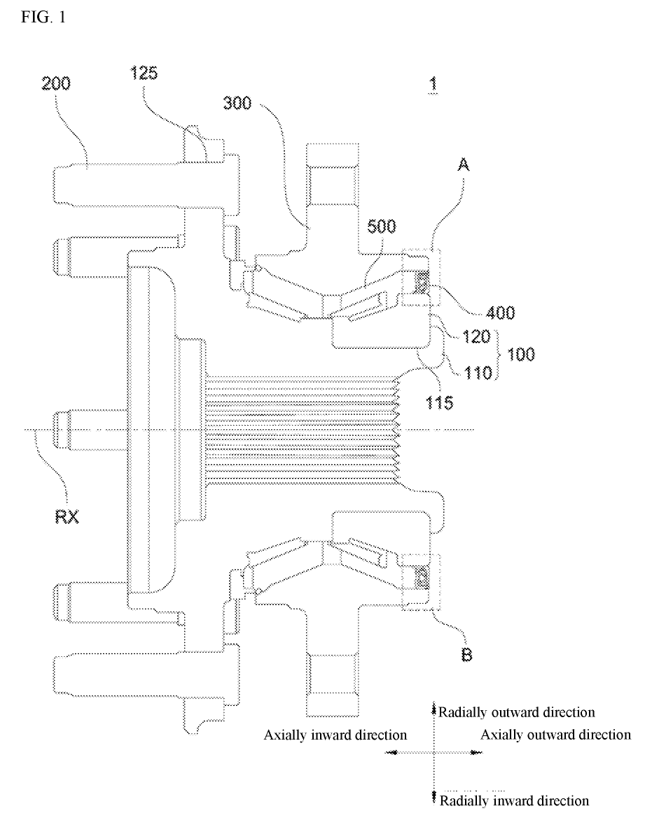

FIG. 1 is a cross-sectional view of a vehicle wheel bearing according to an example embodiment of the present disclosure.

Referring to FIG. 1, a vehicle wheel bearing 1 (hereinafter, simply referred to as a "wheel bearing") may include a rotary element 100, a plurality of wheel mounting bolts 200, an outer ring (or a non-rotary element) 300, and a vehicle wheel bearing seal 400.

the rotary element 100 may include a wheel hub 110 and an inner ring 120. The wheel hub 110 may have a cylindrical shape extending along the axial direction. A stepped portion 115 may be formed on one of both sides of the wheel hub 110, which face each other in the axial direction.

The wheel hub 110 is connected to a wheel and may rotate about an imaginary rotational axis RX parallel to the axial direction.

The inner ring 120 may be disposed to be adjacent to one of the both sides of the wheel hub 110, which face each other in the axial direction. The inner ring 120 may be disposed on the stepped portion 115. The inner ring 120 may be coupled to the wheel hub 110 by being plastically deformed or fastened with a nut or the like in a state of being press-fitted to the stepped portion 115 of the wheel hub 110.

Although not illustrated, the inner ring 120 may have a ring shape. The inner ring 120 may surround an outer peripheral surface of the wheel hub 110.

The inner ring 120 may be connected to the wheel via the wheel hub 110. Thus, when the wheel hub 110 rotates about the imaginary rotational axis RX parallel to the axial direction, the inner ring 120 may be rotated about the imaginary rotational axis RX parallel to the axial direction.

Each of the plurality of wheel mounting bolts 200 extends in the axial direction and may be inserted into a respective one of wheel mounting openings 125 defined by the rotary element 100. The wheel mounting bolts 200 may be provided to be adjacent to the other of the both sides of the wheel hub 110, which face each other in the axial direction. The wheel mounting bolts 200 may be arranged in a circular shape.

Although not illustrated, the wheel may be coupled to the wheel mounting bolts 200. Thus, the rotary element 100 may be connected to the wheel with the wheel mounting bolts 200.

The outer ring 300 may be disposed to be adjacent to one of the both sides of the wheel hub 110, which face each other in the axial direction. When viewed in a radial direction, the outer ring 300 may cover a portion of the wheel hub 110 and the inner ring 120.

The outer ring 300 may be fixed to a vehicle body. Thus, the vehicle wheel bearing 1 may be fixed to the vehicle body. The outer ring 300 is fixed to the vehicle body. When the wheel hub 110 and the inner ring 120 rotate, the outer ring 300 may not be rotated.

The vehicle wheel bearing 1 may further include a plurality of rolling bodies 500 (for example, balls, rollers, or the like). The rolling bodies 500 may be disposed between the wheel hub 110 and the outer ring 300. The rolling bodies 500 may be disposed between the inner ring 120 and the outer ring 300. The rolling bodies 500 may be disposed on an outer peripheral surface of the inner ring 120. The outer peripheral surface of the inner ring 120 may support the rolling bodies 500.

Although not illustrated, a raceway surface may be formed on the outer peripheral surface of the inner ring 120 to support the rolling bodies 500. The rolling bodies 500 may be rotated about the imaginary rotational axis RX parallel to the axial direction along the raceway surface. Thus, through the rolling bodies 500, the inner ring 120 may be rotated relative to the outer ring 300.

Referring to FIG. 1, the vehicle wheel bearing seal 400 may be disposed on one of the both sides of the wheel hub 110, which face each other in the axial direction. As illustrated in FIG. 1, when viewed in the radial direction, a portion of the vehicle wheel bearing seal 400 may be disposed between the outer ring 300 and the inner ring 120. A portion of the vehicle wheel bearing seal 400 may be coupled to an inner peripheral surface of the outer ring 300. The vehicle wheel bearing seal 400 may be coupled to the inner peripheral surface of the outer ring 300 in a press-fitting manner.

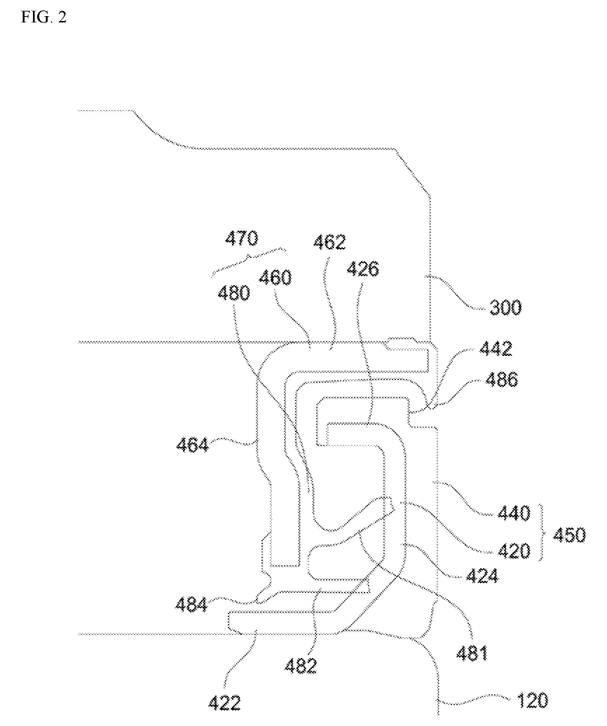

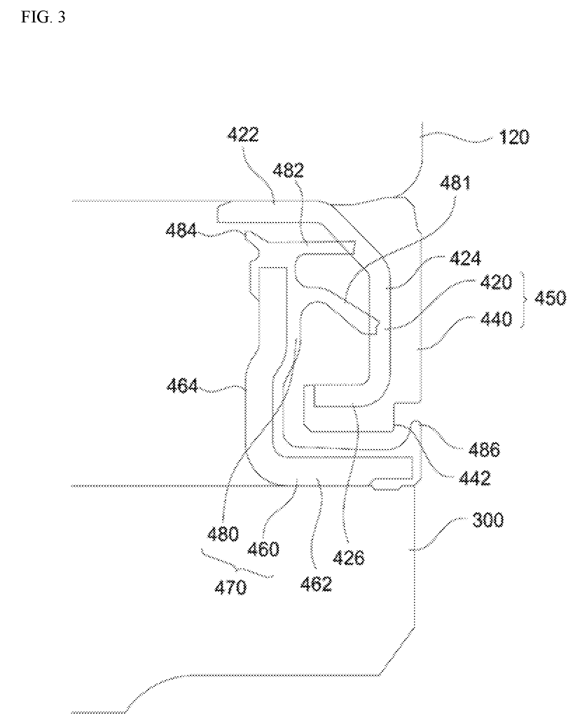

FIG. 2 is an enlarged view of a first region A illustrated in FIG. 1. FIG. 3 is an enlarged view of a second region B illustrated in FIG. 1.

Referring to FIGS. 2 and 3, the vehicle wheel bearing seal 400 may be disposed between the outer ring 300 and the inner ring 120 to cover a gap between the inner ring 120 and the outer ring 300. This makes it possible to prevent external foreign matters from flowing into the gap between the inner ring 120 and the outer ring 300. The vehicle wheel bearing seal 400 will be described in detail with reference to FIGS. 2 and 3.

The vehicle wheel bearing seal 400 may have a ring-shaped shape. The vehicle wheel bearing seal 400 includes a first seal portion 450 and a second seal portion 470.

The first seal portion 450 includes a first support member 420 and a first seal-portion body 440. The first support member 420 is provided on the inner ring 120. The first support member 420 includes a first cylindrical portion 422, a first annular portion 424, and a second cylindrical portion 426.

The first cylindrical portion 422 is formed in a cylindrical shape. The first cylindrical portion 422 is configured such that an inner diameter surface thereof is in contact with an outer diameter surface of the inner ring 120. The first annular portion 424 extends radially outward from an axial outer end portion of the first cylindrical portion 422. Further, a connection portion may be formed integrally with the first cylindrical portion 422 and the first annular portion 424 to connect the first cylindrical portion 422 and the first annular portion 424. The first annular portion 424 is formed in an annular shape. The second cylindrical portion 426 extends axially inward from a radial outer end portion of the first annular portion 424 to face the first cylindrical portion 422. The second cylindrical portion 426 is formed in a cylindrical shape. An axial inner end portion of the second cylindrical portion 426 is located axially inward of an axially inner end portion of the first cylindrical portion 422.

The first seal-portion body 440 is provided to be coupled to the first support member 420. The first seal-portion body 440 is configured to cover outer surfaces of the first annular portion 424 and the second cylindrical portion 426. The first seal-portion body 440 may be made of a rubber material or a plastic material, and may be configured as an encoder in which N and S poles are alternately arranged to generate a change in magnetic field.

The second seal portion 470 includes a second support member 460 and a second seal-portion body 480. The second support member 460 is provided on the outer ring 300. The second support member 460 includes a third cylindrical portion 462 and a second annular portion 464. The third cylindrical portion 462 is formed in a cylindrical shape. The third cylindrical portion 462 is configured such that an outer diameter surface thereof is in contact with the inner diameter surface of the outer ring 300. The third cylindrical portion 462 is provided to be spaced apart from the second cylindrical portion 426 in the radially outward direction.

The second annular portion 464 extends radially inward from an axially inner end portion of the third cylindrical portion 462. The second annular portion 464 is formed in an annular shape. The second annular portion 464 faces the first annular portion 424 while being spaced apart from the first annular portion 424 in the axially inward direction. An end portion of the second annular portion 464 in the radially inward direction is spaced apart from the first cylindrical portion 422 in the radially outward direction.

The second seal-portion body 480 is provided to be coupled to the second support member 460. The second seal-portion body 480 is configured to cover an axial outer surface of the second support member 460, the axial outer end portion of the third cylindrical portion 462, and the radial inner end portion of the second annular portion 464. The second seal-portion body 480 is made of a rubber material. The second seal-portion body 480 may be provided with at least one or more sealing ribs 481, 482 and 484.

Among these, the sealing ribs 481 and 482 are provided such that a surface facing the first annular portion 424 extends toward the first annular portion 424 in the axially outward direction. End portions of the sealing ribs 481 and 482 are provided to be in contact with the inner surface of the first annular portion 424. Among the sealing ribs 481482 and 484, the sealing rib 484 as a grease rib may be provided such that a surface facing the first cylindrical portion 422 extends obliquely in the axially inward direction and the radially inward direction.

The grease rib 484 is provided to prevent grease from leaking externally and is generally configured to be in contact with the inner surface of the first cylindrical portion 422. In the present disclosure, the grease rib 484 is configured to be in non-contact with the inner surface of the first cylindrical portion 422. Accordingly, the grease rib 484 is not brought into contact with the first cylindrical portion 422 so that a sealing drag torque (seal friction torque) is not generated. This improves the fuel efficiency of an automobile.

On the other hand, in general, a vehicle wheel bearing seal is manufactured, assembled, transported, and then mounted on a vehicle wheel bearing. In this case, the seal support member is transported in an assembled state such that the sealing rib disposed near the second support member coupled to the outer ring presses the first support member coupled to the inner ring. As a result, the first support member and the second support member are likely to be separated from each other during the transport. Further, in the present disclosure, the grease rib 484 is not in contact with the inner surface of the first cylindrical portion 422. Thus, the first support member 420 and the second support member 460 are more likely to be separated from each other (as compared to the case in which the grease rib 484 is in contact with the inner surface of the first cylindrical portion 422).

In the present disclosure, the grease rib 484 is configured in a non-contact manner, but the first support member 420 of the first seal portion 450 is constituted with the first cylindrical portion 422, the first annular portion 424, and the second cylindrical portion 426. Thus, the first support member 420 of the first seal portion 450 has a substantially U-like cross section. Further, the second seal-portion body 480 of the second seal portion 470 is formed with a protrusion 486 that protrudes radially inward from an axial outer end portion of a surface facing the second cylindrical portion 426. As a result, the first seal-portion body 440 is formed with a stepped portion 442 depressed in the radially inward direction. The stepped portion 442 is configured to open axially outward and radially outward. The stepped portion 442 is formed in a ring shape along the outer peripheral surface of the first seal-portion body 440 in the radially outward direction.

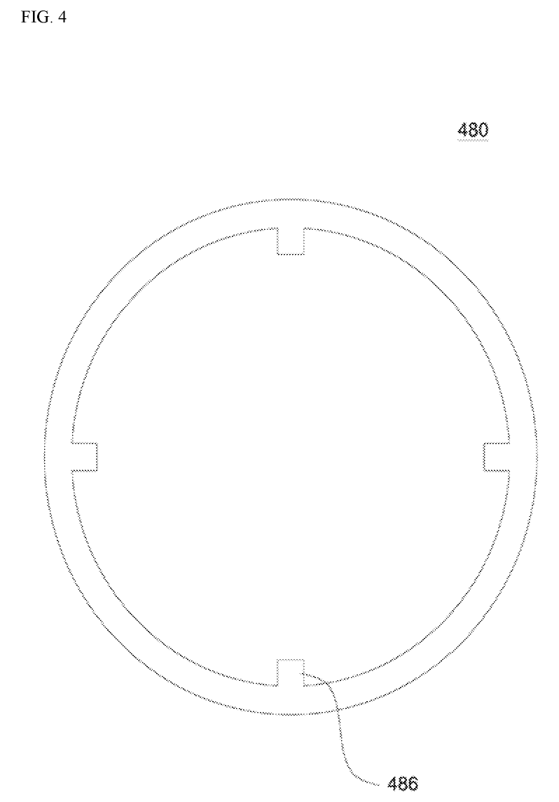

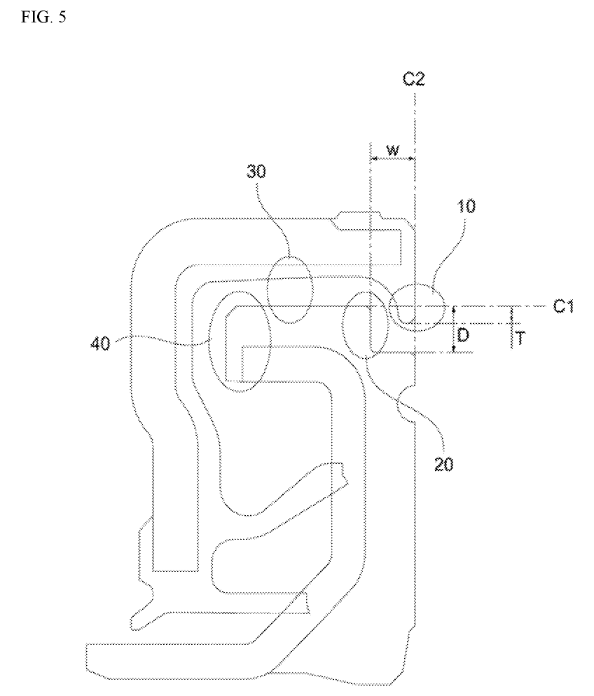

FIG. 4 is a view of the second seal-portion body according to an example embodiment of the present disclosure when viewed in the axially inward direction. A plurality of protrusions 486 may be arranged so as to be spaced apart from each other at equal intervals along the inner peripheral surface at the axial outer end portion of the surface of the second seal-portion body 480 facing the second cylindrical portion 426. Thus, in a structure composed of the protrusions and the stepped portion, the protrusions 486 of the second seal-portion body 480 interfere with the stepped portion 442 of the first seal-portion body 440 so that the separation of the first support member 420 from the second support member 460 is prevented and the second support member 460 is not deviated from the first support member 420. In addition, as illustrated in FIG. 5, the seal according to an example embodiment of the present disclosure is formed with first to fourth labyrinths. That is, a first labyrinth 10 is formed by the protrusions 486, a second labyrinth 20 is formed by the stepped portion 442, a third labyrinth 30 is formed by the first seal-portion body portion covering the second cylindrical portion 426, and a fourth labyrinth 40 is formed by the first seal-portion body covering the end of the second cylindrical portion 426. With this configuration, the sealing property may be further improved.

Each protrusion 486 has an outer surface and an inner surface. The inner surface may be formed as an inclined surface of a linear or rounded shape.

The stepped portion 442 is formed to be opened in the axially outward direction and the radially outward direction. As illustrated in FIG. 5, an axial interference amount T between the protrusion 486 and the stepped portion 442 may be set to 0.1 millimeter (mm) or more. An axial width Wand a radial depth D of the stepped portion 442 with respect to a first imaginary straight line C1 and a second imaginary straight line C2 with reference to a section in which the outer surface of the cross-section of the first seal-portion body 440 has the longest straight line, may be 0.5 mm or more. A length of an outermost-diameter flat section of the first seal-portion body covering the second cylindrical portion 426 may be 1.0 mm or more in the cross section. With this configuration, the first support member 420 and the second support member 460 may be easily assembled during assembly and may be prevented from being separated from each other in the assembled state by the aforementioned interference.

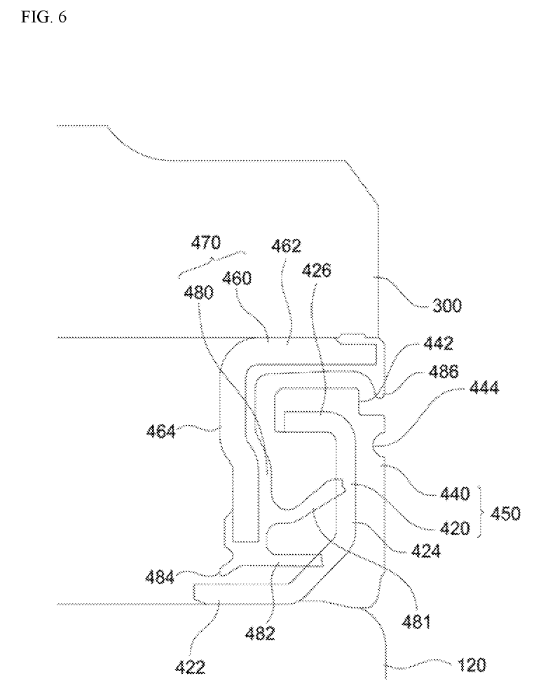

FIG. 6 illustrates a vehicle wheel bearing seal according to another example embodiment of the present disclosure. The example embodiment illustrated in FIG. 6 differs from the example embodiment illustrated in FIG. 2 in that a recess 444 is additionally provided.

As illustrated in FIG. 6, the recess 444 may be formed in an outer surface of a portion covering the first annular portion 424 of the first seal-portion body 440 to be depressed in the axially inward direction. The recess 444 is formed in a ring shape circumferentially in the outer surface. With this configuration, when external foreign matters flow along the outer surface of the first seal-portion body 440, the external foreign matters may be suppressed from flowing to an interior space of the vehicle wheel bearing seal 400 by the recess 444.

Although the present disclosure has been described with reference to the above example embodiments, it should be noted that various modification, and variations can be devised by those skilled in the art to which the present disclosure pertains without departing from the technical spirit and scope of the present disclosure. Further, the example embodiments described herein are merely examples for describing the technical sprit of the present disclosure, and the technical sprit of the present disclosure is not limited to the example embodiments. Further, the scope of the present disclosure should be construed within the appended claims, and all technical ideas falling within the equivalent scope thereof should be interpreted as being included in the scope of the disclosure.

What is claimed is:

1. A vehicle wheel bearing seal (400), comprising:
a first seal portion (450) including a first support member (420) coupled to an inner ring (120) of a vehicle wheel bearing (1) and a first seal-portion body (440) coupled to the first support member (420); and
a second seal portion (470) including a second support member (460) coupled to an outer ring (300) of the vehicle wheel bearing (1) and a second seal-portion body (480) coupled to the second support member (460),
wherein the first support member (420) includes a first cylindrical portion (422) configured to be in contact with an outer diameter surface of the inner ring, a first annular portion (424) extending in a radially outward direction from an axial outer end portion of the first cylindrical portion (422), and a second cylindrical portion (426) extending in an axially inward direction from a radial outer end portion of the first annular portion (424) and configured to face the first cylindrical portion (422), and
wherein the second seal-portion body (480) includes a grease rib (484) configured not to be in contact with the first cylindrical portion (422).

2. The vehicle wheel bearing seal of claim 1, wherein at least one protrusion (486) is formed at an axial outer end portion of the second seal-portion body (480) in a radially inward direction,
wherein a stepped portion (442) is formed in the first seal-portion body (440) to correspond to the at least one protrusion (486), and
wherein the stepped portion (442) is formed to be opened in an axially outward direction and the radially outward direction.

3. The vehicle wheel bearing seal of claim 2, wherein the at least one protrusion (486) has a plurality of protrusions arranged to be spaced apart from each other at equal intervals along an inner peripheral surface of the second seal-portion body (480).

4. The vehicle wheel bearing seal of claim 2, wherein a first labyrinth (10) is formed by the at least one protrusion (486), a second labyrinth (20) is formed by the stepped portion (442), a third labyrinth (30) is formed by the first seal-portion body which covers the second cylindrical portion (426), and a fourth labyrinth (40) is formed by the first seal-portion body which covers an end of the second cylindrical portion (426).

5. The vehicle wheel bearing seal of claim 1, wherein the second support member (460) includes a third cylindrical portion (462) configured to be in contact with an inner diameter surface of the outer ring (300), and a second annular portion (464) extending in the radially inward direction from an axial outer end portion of the third cylindrical portion (462), and
wherein the second seal-portion body (480) is configured to cover all of an axial outer surface of the second support member (460), a radial inner end portion of the second annular portion (464), and the axial outer end portion of the third cylindrical portion (462).

6. The vehicle wheel bearing seal of claim 2, wherein an axial interference amount T between the at least one protrusion (486) and the stepped portion (442) is 0.1 mm or more.

7. The vehicle wheel bearing seal of claim 2, wherein an inner surface of the at least one protrusion (486) is formed as an inclined surface.

8. The vehicle wheel bearing seal of claim 2, wherein the stepped portion (442) is formed in a ring shape along a radial outer peripheral surface of the first seal-portion body (440).

9. The vehicle wheel bearing seal of claim 2, wherein a length of an outermost diameter flat section of the first seal-portion body (440) which covers the second cylindrical portion (426) in the stepped portion (442) is 1.0 mm or more, and
wherein an axial width and a radial depth of the stepped portion (442) are 0.5 mm or more, respectively.

10. The vehicle wheel bearing seal of claim 1, wherein a recess (444) is formed in an outer surface of a portion of the first seal-portion body (440) which covers the first annular portion (424) to be depressed in the axially inward direction and to be opened in an axially outward direction.

11. A vehicle wheel bearing comprising the vehicle wheel bearing seal (400) of any one of claim 1.
